(19) United States
(12) Patent Application Publication
(10) Pub. No.: US 2010/0094684 A1
(43) Pub. Date: Apr. 15, 2010

(54) PARTICIPANT DATA GATHERING FOR EXPERIENCE MARKETING EVENT

(75) Inventors: Richard S. Weldon, Addison, TX (US); David K. Hess, Dallas, TX (US); Michael D. Gilvar, Gunter, TX (US); Eugene C. Wardynski, West Point, NY (US)

Correspondence Address: DEPARTMENT OF THE ARMY;LEGAL OFFICE, AMSAM - L - G - I, U.S. ARMY AVIATION & MISSILE COMMAND, REDSTONE ARSENAL, AL, 35898-5000, US

(73) Assignee: The United States of America as represented by the Secretary of the Army, Washington, DC (US)

(21) Appl. No.: 12/468,331

(22) Filed: May 19, 2009

Related U.S. Application Data
(60) Provisional application No. 61/056,382, filed on May 27, 2008.

(51) Int. Cl. G06Q 30/00; G06Q 10/00; G06Q 50/00

(52) U.S. Cl. 705/10; 705/14.53

(57) ABSTRACT

Embodiments of the present invention address deficiencies of the art in respect to marketing and provide a novel and non-obvious method, computer system and computer program product for collecting information at experience marketing events. In one embodiment of the invention, a method for collecting information from participants at an experience marketing event is provided. The method can include collecting written information from a participant at a computer terminal and collecting location information from the participant in a defined location of the experience marketing event, wherein the location information is collected from an electronic marker worn by the participant. The method may further include collecting game play data from the participant via a video game provided at the experience marketing event and recording the written information, the location information and the game play data in a record associated with an identity of the participant.

### PRIORITY CLAIMED

Benefit is claimed to provisional application No. 61/056,382 of the same title which was filed on May 27, 2008.

### STATEMENT REGARDING FEDERALLY SPONSORED RESEARCH OR DEVELOPMENT AND DEDICATORY CLAUSE

This invention was made with Government support under a contract awarded by the U.S. Army (Agreement # W31P4Q-05-A-0031, Subcontract #4600008759). The invention described herein may be manufactured, used and licensed by or for the U.S. Government for governmental purposes without payment of any royalties thereon.

### BACKGROUND OF THE INVENTION

1. Field of the Invention

The present invention relates to marketing, and more particularly to data gathering at experience marketing events.

2. Description of the Related Art

Marketing methods are used for a variety of purposes, such as commercial advertising, political advertising, cause and appeal marketing, or simply for the purpose of spreading non-commercial content. Traditionally, marketing campaigns are implemented by placing the marketing content adjacent to non-marketing content, such as the placement of a television advertisement or a magazine advertisement. For a campaign to be effective, marketers rely on the popularity of the complimentary non-marketing content; therefore, the cost of different placements varies depending on the size of the audience for the non-marketing content. Marketing methods such as these have some inherent disadvantages. First, the cost of such marketing methods are high, since the revenue generated by the advertisements is relied upon for the development of the complimentary non-marketing content. In addition, the public has been shown to perceive these methods as intrusive to the non-marketing content.

Another method of marketing, direct marketing, relies on smaller, more deliberately targeted messages, using either direct mail, the telephone (telemarketing), direct email, or the variety of direct marketing methods on the internet (e.g., banner advertising, pop-up advertising, search engine advertising). These methods allow a broader range of marketers to reach specific individuals who could be identified through publicly or privately disclosed demographic or psychographic data generally known about the individuals (e.g. mailing address, telephone number, age, shopping habits, web browsing habits, etc.). These methods also have several disadvantages. The sheer volume of competing marketing messages that exist in these mediums make it difficult for a single marketer's message to be acknowledged. Also, these mediums are also usually perceived as intrusive to the person receiving the advertisement.

Another marketing method is known as experience marketing. Experience marketing events are events sponsored by a marketer that creates a novel experience for a targeted first-tier audience, and relies on the novelty of the experience to trigger a chain reaction in which the first-tier audience is compelled to tell their friends and other associates about the experience, and to encourage those friends and associates to continue to tell others. One example of an experience marketing event includes a large tent set up at a gathering event such as a county fair or an air show, wherein inside the tent various displays promoting a product or service are exhibited, as well as a three dimensional simulator, with which participants can interact. Another example of an experience marketing event includes a large obstacle course or climbing wall set up at a gathering event wherein participants can perform activities as well as browse through promotions for products or services.

Experience marketing is more broadly affordable than other types of marketing, since the scale of the experience may range from a very small experience (e.g., a street performance, poster, graffiti, or the speaking of a brand name in an exclusive venue), to a larger experience (e.g. experiences within retail stores, sporting event sponsorship, films, entertainment events). Another advantage of experience marketing is that the marketer is establishing a relationship with an individual, who, in reaction to a positive experience provided by the marketer, is compelled to work on behalf of the marketer to endorse the marketer's offering directly to a “second tier”: the individual's friends and associates.

Participants at an experience marketing event perform various actions and exhibit behavior that can be used by a marketer to gleam information about the effectiveness of the marketing event and about a participant's feelings towards the product or service being promoted. The amount of time a participant spends at a display can tell the marketer much about how the participant feels about the display and the product being promoted. Further, the number of times a participant returns to the experience marketing event is valuable information for a marketer. Much of this information, however, is not typically gathered. At most, participants are sometimes asked for their contact information at a single point in time and no other information is gathered from the experience marketing event.

Therefore, there is a need to overcome the deficiencies with the prior art, and more specifically, there is a need for a more efficient and expansive way of collecting information about a participant's behavior and actions at an experience marketing event.

### BRIEF SUMMARY OF THE INVENTION

Embodiments of the present invention address deficiencies of the art in respect to marketing and provide a novel and non-obvious method, computer system and computer program product for collecting information at experience marketing events. In one embodiment of the invention, a method for collecting information from participants at an experience marketing event is provided. The method can include collecting written information from a participant at a computer terminal and collecting location information from the participant in a defined location of the experience marketing event, wherein the location information is collected from an electronic marker worn by the participant. The method may further include collecting game play data from the participant via a video game provided at the experience marketing event and recording the written information, the location information and the game play data in a record associated with an identity of the participant.

In another embodiment of the invention, a computer program product comprising a computer usable medium embodying computer usable program code for collecting information from participants of an experience marketing event is provided. The computer program product can include computer usable program code for collecting written information from a participant at a computer terminal and collecting location information from the participant in a defined location of the experience marketing event, wherein the location information is collected from an electronic marker worn by the participant. The computer program product can further include computer usable program code for collecting game play data from the participant via a video game provided at the experience marketing event and recording the written information, the location information and the game play data in a record associated with an identity of the participant.

In yet another embodiment of the invention, a computer system for collecting information from participants of an experience marketing event is provided. The computer system can include a computer terminal for collecting written information from a participant and a scanner for collecting location information from the participant in a defined location of the experience marketing event, wherein the location information is collected from an electronic marker worn by the participant. The computer system can further include a video game system for collecting game play data from the participant via a video game and memory for storing the written information, the location information and the game play data in a record associated with an identity of the participant.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating the various components of a dynamic data gathering system for an experience marketing event, in accordance with one embodiment of the present invention; and

FIG. 2 is a flow chart depicting a general process for gathering data at an experience marketing event, according to one embodiment of the present invention.

### DETAILED DESCRIPTION OF THE INVENTION

Embodiments of the present invention address deficiencies of the art in respect to marketing and provide a novel and non-obvious method, computer system and computer program product for collecting information at experience marketing events. In one embodiment of the invention, a method for collecting information from participants at an experience marketing event is provided. The method can include collecting written information from a participant at a computer terminal and collecting location information from the participant in a defined location of the experience marketing event, wherein the location information is collected from an electronic marker worn by the participant. An electronic marker may be an RFID tag. The method may further include collecting game play data from the participant via a video game provided at the experience marketing event and recording the written information, the location information and the game play data in a record associated with an identity of the participant.

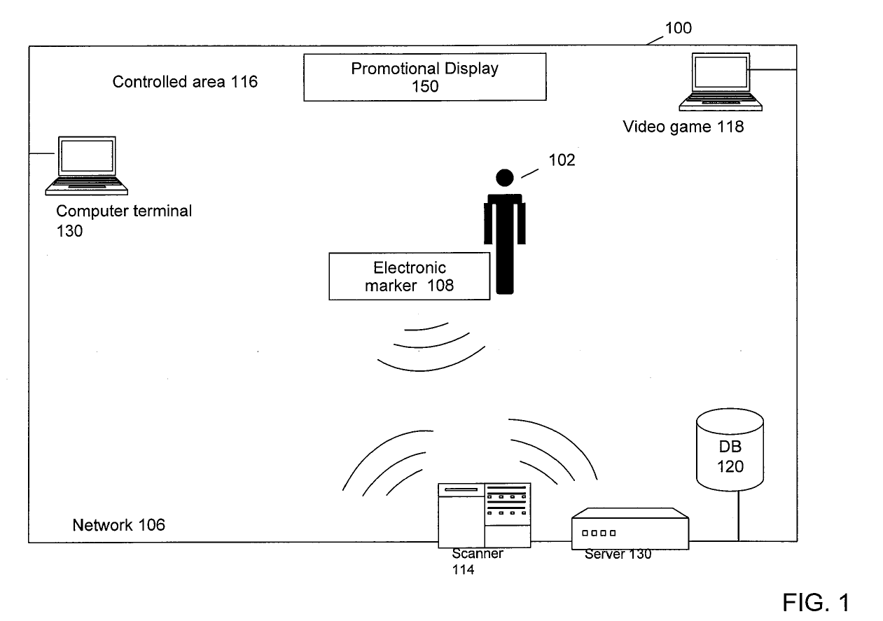

FIG. 1 is a block diagram illustrating the various components of a dynamic data gathering system 100 for an experience marketing event, in accordance with one embodiment of the present invention. FIG. 1 shows a controlled area 116 that may comprise a room, a building, an area, a group of rooms or buildings or a section of an area. The dynamic data gathering system 100 monitors assets and individuals within the controlled area 116.

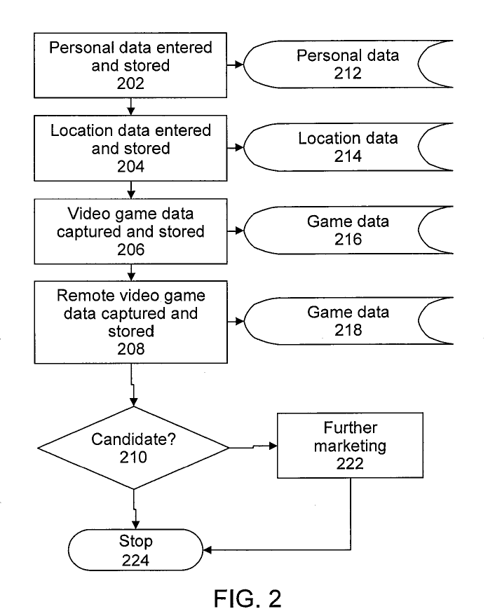

Shown in FIG. 1 is a server 130 which substantially performs the data gathering functions of the present invention. The server 130 comprises a computer or group of computers that are coupled, such as via a network 106, with the database 120, the computer terminal 130, the video game station 118 and the scanner 114. All information gathered about individual 102 by server 130 is stored in a unique record for the individual 102 in the database 120. The processes performed by server 130 are described in greater detail below with reference to FIG. 2.

In an embodiment of the present invention, the computer systems of computers 130, 118 and server 130 are one or more Personal Computers (PCs), Personal Digital Assistants (PDAs), hand held computers, palm top computers, lap top computers, smart phones, game consoles or any other information processing devices. A PC can be one or more IBM or compatible PC workstations running a Microsoft Windows or LINUX operating system, one or more Macintosh computers running a Mac OS operating system, or an equivalent. In another embodiment, the computer systems of computers 130, 118 and server 130 are a server system, such as IBM RS/6000 workstations and servers running the AIX operating system.

In an embodiment of the present invention, the network 106 is a circuit switched network, such as the Public Service Telephone Network (PSTN). In another embodiment, the network 106 is a packet switched network. The packet switched network is a wide area network (WAN), such as the global Internet, a private WAN, a local area network (LAN), a telecommunications network or any combination of the above-mentioned networks. In yet another embodiment, the structure of the network 106 is a wired network, a wireless network, a broadcast network or a point-to-point network.

FIG. 1 further shows an individual 102, such as a participant in the experience marketing event, in possession of an electronic marker 108, which may be worn on his or her person. Alternatively, the electronic marker 108 can be coupled to any transport mechanism, such as a wheelchair, a vehicle or a two-wheeled electric vehicle. The electronic marker 108 may be in the form of a pass card or electronic pass key or electronic marker 108 may be an RFID tag, magneto acoustic marker, a magnetic stripe card, a smart card or any other item that can be read by interfacing with the item, scanning the item or by reading of identifying data emitted by the item. In an embodiment of the present invention, an alternative for the electronic marker 108 is a biometric method for identifying the individual 102.

The electronic marker 108 is associated with a unique identifier that is associated by the server 130 with a unique record for the individual 102 at database 120.

FIG. 1 further shows a computer terminal 130 that may reside at an entrance of the experience marketing event. At the computer terminal 130, the individual 102 may enter information such as identifying information (name address, telephone number, social security number, drivers license information, etc.), biographical information (work history, educational history, future plans, etc.) and demographical information (income information, cultural information, race information, educational level, etc.). The individual 102 may enter this information via a keyboard, mouse or voice prompt. The individual 102 may also enter this information verbally by providing to an administrator who enters the information via a keyboard, mouse or voice prompt.

All information entered by the individual 102 at computer terminal 130 is associated by the server 130 with the unique record for the individual 102 at database 120.

FIG. 1 further shows a scanner 114 located along a perimeter of area 116. The scanner 114 comprises a unit that utilizes radio frequency or magnetic emissions to read information from the electronic marker 108. The scanner 114 captures the locations of the electronic marker (and, by extension, the individual 102) and sends it to the server 130. All information captured by scanner 114 about individual 102 is associated by the server 130 with the unique record for the individual 102 at database 120.

The information captured by the scanner 114 and stored by server 130 may included a list including a defined location of the participant 102 at given times, a list including an amount of time the participant 102 spent at predefined locations, a list including identities of other participants that were present in a vicinity of the participant 102 for a predefined period of time and a location path showing a location of the participant 102 over time. For example, the scanner 114 may capture information regarding the amount of time the participant 102 spent near promotional display 150.

FIG. 1 further shows a video game station 118, which may comprise a computer or server that provides a video game or other simulation to the individual 102. The video game station 118 allows a user to play the video game or simulation as game play data about the individual's game play is captured and sent to server 130. Examples of the game play data that is captured includes a measure of performance of the participant in the video game, a list of selections made by the participant in the video game and a list of locations of the participant's avatar in the video game. All information captured by video game station 118 about the game play of individual 102 is associated by the server 130 with the unique record for the individual 102 at database 120.

In one embodiment of the present invention, the individual 102 is provided with version of the video game of station 118 on a CD or DVD so that the individual 102 can install, play and enjoy the video game at his home or work. The CD or DVD is encoded with a unique identifier that corresponds to the unique identifier of the individual 102. If the individual plays the game on a computer that is connected to the Internet or the World Wide Web, game play data may be gathered and sent via the network to the server 130. All information captured about the game play of individual 102 is associated by the server 130 with the unique record for the individual 102 at database 120.

Alternatively, the individual 102 may be provided with a password or identifier to play the game online or to be able to download the game from a web site. Whichever method is used, the game play data of the individual 102 is gathered and sent via the network to the server 130. All information captured about the game play of individual 102 is associated by the server 130 with the unique record for the individual 102 at database 120.

Subsequent to the gathering of data about individual 102 from the computer terminal 130, the video game 118, the scanner 114 and game play of the video game in a location remote from the experience marketing event, the unique record of the individual 102 may be reviewed to determine whether the individual 102 is a candidate for further marketing. To this end, the server 130 reads a set of criteria, which may include a set of attribute values, such as, age>18, gender is male and location is Midwest, or age>30, gender is female and educational level is greater than college. The server 130 may then compare the criteria to the information in the unique record for the individual 102. If the information in the unique record for the individual 102 meets the criteria that were read, then the individual 102 is a candidate for further marketing such as direct mail marketing or person-to-person marketing.

FIG. 2 is a flow chart depicting a general process for gathering data at an experience marketing event, according to one embodiment of the present invention. The process of FIG. 2 provides a process by which the dynamic data gathering system 100 captures data about individual 102 and determines whether the individual 102 is a candidate for further marketing.

In step 202, the individual 102 enters the controlled area 116 of an experience marketing event and enters information 212 about himself into computer terminal 130, which information is associated by the server 130 with the unique record for the individual 102 at database 120.

In step 204, the individual 102 is provided with an electronic marker 108, which enables the scanner 114 to capture location information 214 about the individual in the controlled area 116. The location information is associated by the server 130 with the unique record for the individual 102 at database 120.

In step 206, the individual 102 plays a video game or simulation at video game station 118 as game play data 216 about the individual's game play is captured and sent to server 130. The game play data is associated by the server 130 with the unique record for the individual 102 at database 120.

In step 208, the individual 102 is provided with a version of the video game of station 118 on a CD or DVD so that the individual 102 can install, play and enjoy the video game at his home or work. If the individual plays the game on a computer that is connected to the Internet or the World Wide Web, game play data 218 may be gathered and sent via the network to the server 130. The game play data is associated by the server 130 with the unique record for the individual 102 at database 120.

In step 210, the unique record of the individual 102 is reviewed to determine whether the individual 102 is a candidate for further marketing. If the information in the unique record for the individual 102 meets defined criteria, then the individual 102 is a candidate for further marketing. In step 222, the individual 102 is subjected to further marketing. If the information in the unique record for the individual 102 does not meet defined criteria, then the individual 102 is not a candidate for further marketing. In step 224, the control flow of FIG. 2 ceases.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

We claim:

1. A method for collecting information from participants of an experience marketing event, comprising:
collecting written information from a participant at a computer terminal;
collecting location information from the participant in a defined location of the experience marketing event, wherein the location information is collected from an electronic marker worn by the participant;
collecting game play data from the participant via a video game provided at the experience marketing event; and
recording the written information, the location information and the game play data in a record associated with an identity of the participant.

2. The method of claim 1, further comprising:
reading a set of criteria; and
determining that the participant is a candidate for further marketing if the information in the record meets the criteria.

3. The method of claim 2, wherein the first step of collecting comprises:
collecting written information from a participant at a computer terminal, wherein the written information includes at least one of:
identifying information for the participant;
biographical information for the participant; and
demographical information for the participant.

4. The method of claim 3, wherein the second step of collecting comprises:
collecting location information from the participant in a defined location of the experience marketing event, wherein the location information is collected from an electronic marker worn by the participant, wherein the location information includes at least one of:
a list including a defined location of the participant at given times;
a list including an amount of time the participant spent at predefined locations;
a list including identities of other participants that were present in a vicinity of the participant for a predefined period of time; and
a location path showing a location of the participant over time.

5. The method of claim 4, wherein the third step of collecting comprises:
collecting game play data from the participant via a video game provided at the experience marketing event, wherein the game play data includes at least one of:
a measure of performance of the participant in the video game;
a list of selections made by the participant in the video game; and
a list of locations of the participant's avatar in the video game.

6. The method of claim 2, wherein the step of determining comprises:
determining that the information in the record matches attributes defined in the criteria.

7. A computer program product comprising a computer usable medium embodying computer usable program code for collecting information from participants of an experience marketing event, comprising:
computer usable program code for collecting written information from a participant at a computer terminal;
computer usable program code for collecting location information from the participant in a defined location of the experience marketing event, wherein the location information is collected from an electronic marker worn by the participant;
computer usable program code for collecting game play data from the participant via a video game provided at the experience marketing event; and
computer usable program code for recording the written information, the location information and the game play data in a record associated with an identity of the participant.

8. The computer program product of claim 7, further comprising:
computer usable program code for reading a set of criteria and determining that the participant is a candidate for further marketing if the information in the record meets the criteria.

9. The computer program product of claim 8, wherein the first computer usable program code for collecting comprises:
computer usable program code for collecting written information from a participant at a computer terminal, wherein the written information includes at least one of:
identifying information for the participant;
biographical information for the participant; and
demographical information for the participant.

10. The computer program product of claim 9, wherein the second computer usable program code for collecting comprises:
computer usable program code for collecting location information from the participant in a defined location of the experience marketing event, wherein the location information is collected from an electronic marker worn by the participant, wherein the location information includes at least one of:
a list including a defined location of the participant at given times;
a list including an amount of time the participant spent at predefined locations;
a list including identities of other participants that were present in a vicinity of the participant for a predefined period of time; and
a location path showing a location of the participant over time.

11. The computer program product of claim 10, wherein the third computer usable program code for collecting comprises:
computer usable program code for collecting game play data from the participant via a video game provided at the experience marketing event, wherein the game play data includes at least one of:
a measure of performance of the participant in the video game;
a list of selections made by the participant in the video game; and
a list of locations of the participant's avatar in the video game.

12. The computer program product of claim 8, wherein the computer usable program code for determining comprises:
computer usable program code for determining that the information in the record matches attributes defined in the criteria.

13. A computer system for collecting information from participants of an experience marketing event, comprising:
a computer terminal for collecting written information from a participant;
a scanner for collecting location information from the participant in a defined location of the experience marketing event, wherein the location information is collected from an electronic marker worn by the participant;
a video game system for collecting game play data from the participant via a video game; and
memory for storing the written information, the location information and the game play data in a record associated with an identity of the participant.

14. The computer system of claim 13, further comprising:
a processor configured for reading a set of criteria and determining that the participant is a candidate for further marketing if the information in the record meets the criteria.

15. The computer system of claim 14, wherein the written information includes at least one of:
identifying information for the participant;
biographical information for the participant; and
demographical information for the participant.

16. The computer system of claim 15, wherein the location information includes at least one of:
a list including a defined location of the participant at given times;
a list including an amount of time the participant spent at predefined locations;
a list including identities of other participants that were present in a vicinity of the participant for a predefined period of time; and
a location path showing a location of the participant over time.

17. The computer system of claim 16, wherein the game play data includes at least one of:
a measure of performance of the participant in the video game;
a list of selections made by the participant in the video game; and
a list of locations of the participant's avatar in the video game.

18. The computer system of claim 14, wherein the step of determining comprises:
determining that the information in the record matches attributes defined in the criteria.
